(19) United States
(12) Patent Application Publication
(10) Pub. No.: US 2011/0229618 A1
(43) Pub. Date: Sep. 22, 2011

(54) Brewed Liquid Filtering System, Brewed Liquid Filtering Method, and Brewed Liquid Manufacturing Method

(76) Inventors: Tadahiro Ohmi, Miyagi (JP); Hisayoshi Kobayashi, Tokyo (JP)

(21) Appl. No.: 13/131,632

(22) PCT Filed: Nov. 11, 2009
(86) PCT No.: PCT/JP2009/069182

§ 371 Date: May 27, 2011

(30) Foreign Application Priority Data
Nov. 28, 2008 (JP) 2008-305390

(51) Int. Cl. C12H 1/16; B01D 35/18; B01D 35/16; C12G 3/08

(52) U.S. Cl. 426/490; 210/332; 210/184; 210/333.01

(57) ABSTRACT

An object of the present invention is to provide a brewed liquid filtering system which is capable of reducing a production cost and which has a structure suitable for cleaning of a filter. A brewed liquid filtering system 1 of the present invention has a first branching pipe and a second branching pipe. The first branching pipe and the second branching pipe are provided with a first filter and a second filter, respectively.

The first branching pipe is provided with first branching pipe valves V1-1 and V1-2 arranged so that the first filter is interposed therebetween, and connected to first cleaning pipes 10-31 and 10-32 which are arranged closer to the first filter than the first branching pipe valves V1-1 and V1-2.

The second branching pipe is provided with second branching pipe valves V2-1 and V2-2 arranged so that the second filter is interposed therebetween, and connected to second cleaning pipes 10-33 and 10-34 which are arranged closer to the second filter than the second branching pipe valves V2-1 and V2-2.

### TECHNICAL FIELD

This invention relates to a brewed liquid filtering system, a brewed liquid filtering method using the brewed liquid filtering system, and a brewed liquid manufacturing method.

### BACKGROUND ART

A brew, such as a draft beer and a Ginjo-shu (premium Japanese sake), is manufactured by fermenting a saccharified material with bacteria, such as yeasts, added thereto to produce a brewed liquid, filtering the brewed liquid by a filter to remove the bacteria from the brewed liquid, and filling a bottle, which is completely sterilized by high-temperature sterilization or the like, with a premium sake or the like in a state where no bacteria is present (Patent Document 1).

By delivering such a brew to a customer, it is possible to deliver an excellent sake kept in a state exactly when it is produced.

Herein, in a manufacturing technique of the brewed liquid, during the process of filtering the brewed liquid by the filter, the bacteria caught in the filter vigorously proliferate. Therefore, a line must be frequently stopped to clean and sterilize the filter. As a consequence, there is a problem that a production cost is not reduced.

In view of the above, for example, as disclosed in Patent Document 2, there is known a structure having a plurality of filters to prevent the line from being stopped (Patent Document 2).

Further, as a related technology of a filtering device, Patent Document 3 discloses a structure provided with a plurality of filters, in which the filters can alternately be cleaned by allowing a part of a filtered liquid to flow backward to one of the filters (Patent Document 3).

### PRIOR ART DOCUMENTS

### Patent Documents

Patent Document 1: JP-A-10-42851

Patent Document 2: JP-A-07-143873

Patent Document 3: JP-A-11-137976

### SUMMARY OF THE INVENTION

### Problem to be Solved by the Invention

However, the structure of Patent Document 2 is insufficient because no structure suitable for cleaning of the filters is disclosed.

The structure of Patent Document 3 is a structure in which cleaning is performed by allowing a part of the filtered liquid to flow backward to one of the filters. If the above-mentioned structure is applied to the manufacturing technique of the brewed liquid, a part of the brewed liquid after filtering is used for cleaning. This results in a problem that a production cost is not reduced.

The present invention has been made in view of the above-mentioned problem. It is an object of the present invention to provide a brewed liquid filtering system which is capable of reducing a production cost and which has a structure suitable for cleaning of a filter.

It is another object of the present invention to provide a brewed liquid manufacturing method capable of reducing a production cost.

### Means to Solve the Problem

In order to solve the above-mentioned problem, the first invention provides a brewed liquid filtering system characterized by comprising a first branching pipe having a first filter and allowing a brewed liquid to flow therein and thereout, a second branching pipe having a second filter and allowing the brewed liquid to flow therein and thereout, a pair of first branching pipe valves provided to the first branching pipe so that the first filter is interposed therebetween, a pair of second branching pipe valves provided to the second branching pipe so that the second filter is interposed therebetween, a pair of first cleaning pipes which are connected to the first branching pipe so that the first filter is interposed therebetween, which are connected closer to the first filter than the pair of first branching pipe valves, and which are openable and closable, and a pair of second cleaning pipes which are connected to the second branching pipe so that the second filter is interposed therebetween, which are connected closer to the second filter than the pair of second branching pipe valves, and which are openable and closable.

The second invention provides a brewed liquid filtering method characterized by using a brewed liquid filtering system comprising, a first branching pipe having a first filter and allowing a brewed liquid to flow therein and thereout, a second branching pipe having a second filter and allowing the brewed liquid to flow therein and thereout, a pair of first branching pipe valves provided to the first branching pipe so that the first filter is interposed therebetween, a pair of second branching pipe valves provided to the second branching pipe so that the second filter is interposed therebetween, a pair of first cleaning pipes which are connected to the first branching pipe so that the first filter is interposed therebetween, which are connected closer to the first filter than the pair of first branching pipe valves, and which are openable and closable, and a pair of second cleaning pipes which are connected to the second branching pipe so that the second filter is interposed therebetween, which are connected closer to the second filter than the pair of second branching pipe valves, and which are openable and closable, the method comprising the steps of (a) filtering the brewed liquid using the first filter by opening the pair of first branching pipe valves and closing the pair of second branching pipe valves to allow the brewed liquid to flow into the first branching pipe (b) filtering the brewed liquid using the second filter by closing the first branching pipe valves and opening the second branching pipe valves, when the time for cleaning of the first filter has come, to allow the brewed liquid to flow into the second branching pipe; and (c) cleaning the first filter by opening the first cleaning pipes and allowing a cleaning liquid to flow from the first cleaning pipe to the first filter in a direction opposite to an inflow direction of the brewed liquid.

The third invention provides a brewed liquid manufacturing method characterized by including, as a process, the brewed liquid filtering method described in the second invention.

### EFFECT OF THE INVENTION

According to the present invention, it is possible to provide a brewed liquid filtering system which is capable of reducing a production cost and which has a structure suitable for cleaning of a filter.

### BRIEF DESCRIPTION OF THE DRAWING:

FIG. 1 is a view showing a schematic structure of a brewing apparatus 11.

FIG. 2 is a view showing a structure of a brewed liquid filtering system 1.

FIG. 3 is a view showing a process of filtering a brewed liquid using the brewed liquid filtering system 1.

FIG. 4 is a view showing the process of filtering the brewed liquid using the brewed liquid filtering system 1.

FIG. 5 is a view showing the process of filtering the brewed liquid using the brewed liquid filtering system 1.

FIG. 6 is a view showing a structure of a brewed liquid filtering system 1a.

FIG. 7 is a view showing a structure of a brewed liquid filtering system 1b.

FIG. 8 is a view showing a structure of a brewed liquid filtering system 1c.

FIG. 9 is a view showing a structure of a brewed liquid filtering system 1d.

FIG. 10 is an enlarged view of a portion around a first cleaning pipe 10-31 in FIG. 9.

FIG. 11 is an enlarged view of a portion around a second cleaning pipe 10-33 in FIG. 9.

FIG. 12 is a view showing a process of filtering a brewed liquid using the brewed liquid filtering system 1d.

FIG. 13 is a view showing the process of filtering the brewed liquid using the brewed liquid filtering system 1d.

FIG. 14 is a view showing the process of filtering the brewed liquid using the brewed liquid filtering system 1d.

FIG. 15 is a view showing the process of filtering the brewed liquid using the brewed liquid filtering system 1d.

FIG. 16 is a view showing the process of filtering the brewed liquid using the brewed liquid filtering system 1d.

FIG. 17 is a view showing the process of filtering the brewed liquid using the brewed liquid filtering system 1d.

FIG. 18 is a view showing the process of filtering the brewed liquid using the brewed liquid filtering system 1d.

FIG. 19 is a view showing the process of filtering the brewed liquid using the brewed liquid filtering system 1d.

### MODE FOR EMBODYING THE INVENTION

Hereinbelow, embodiments of the present invention will be described in detail with reference to the drawing.

First, a brewed liquid filtering system 1 according to a first embodiment will be described.

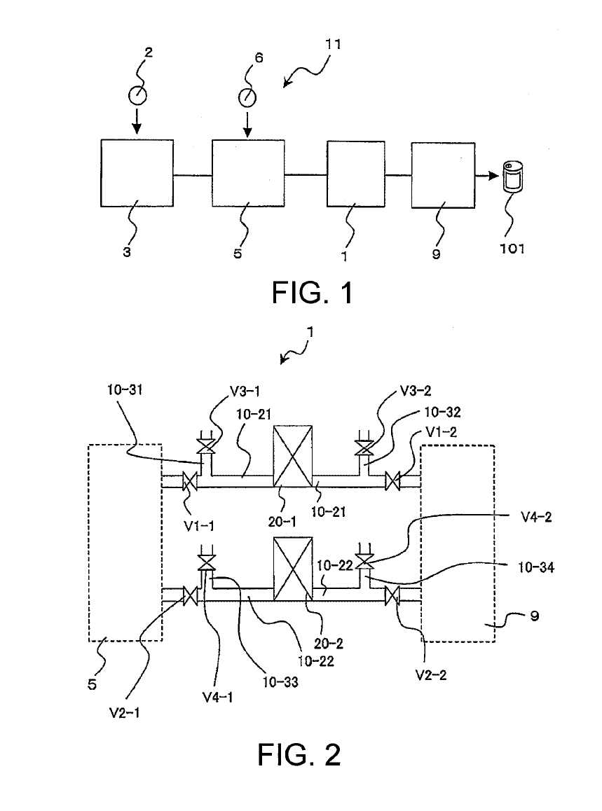

At first referring to FIG. 1, description will briefly be made about a schematic structure of a brewing apparatus 11 having the brewed liquid filtering system 1 and a brewed liquid manufacturing method.

Herein, as the brewing apparatus, a device for brewing a Japanese sake or a beer is disclosed.

First, the schematic structure will be described.

As shown in FIG. 1, the brewing apparatus 11 comprises a saccharification device 3 for saccharifying a material, a fermentation device 5 for fermenting the saccharified material to manufacture a brewed liquid, the brewed liquid filtering system 1 for removing bacteria such as yeasts from the brewed liquid, and a filling or packaging device 9 for filling a container, such as a can and a bottle, with the brewed liquid from which the bacteria have been removed.

Next, the brewed liquid (brew) manufacturing method will be described.

When the brewed liquid is manufactured, at first, a material 2, such as rice or barley, and water are put into the saccharification device 3, mixed therein, and kept at a predetermined temperature to thereby saccharify the material.

Next, the saccharified material is sent to the fermentation device 5 where the saccharified material is kept at a predetermined temperature with bacteria, such as yeasts 6 added thereto. As a consequence, the saccharified material is fermented to manufacture the brewed liquid.

Next, the brewed liquid is sent to the brewed liquid filtering system 1 and filtered by a filter which will be described hereinunder. Thus, the bacteria in the brewed liquid is removed.

Finally, the brewed liquid is sent to the filling device 9 to fill a container, such as a can and a bottle, with the brewed liquid.

By the above-described processes, a brew 101 is manufactured.

Next, referring to FIGS. 2 through 5, a structure of the brewed liquid filtering system 1 and a filtering method will be described.

First, referring to FIG. 2, the structure of the brewed liquid filtering system 1 will be described.

As shown in FIG. 2, the brewed liquid filtering system 1 is arranged so as to connect the fermentation device 5 and the filling device 9 and has a first branching pipe 10-21 and a second branching pipe 10-22 which allow the brewed liquid to flow therein and thereout.

The first branching pipe 10-21 and the second branching pipe 10-22 are provided with a first filter 20-1 and a second filter 20-2 for removing bacteria, respectively.

The first branching pipe 10-21 is provided with a pair of first branching pipe valves V1-1 and V1-2 which are arranged so that the first filter 20-1 is interposed therebetween and which are adapted to open and close the first branching pipe 10-21.

The first branching pipe 10-21 is further connected to a pair of first cleaning pipes 10-31 and 10-32 which are connected thereto so that the first filter 20-1 is interposed therebetween and which are connected closer to the first filter 20-1 than the first branching pipe valves V1-1 and V1-2.

The first cleaning pipes 10-31 and 10-32 are provided with first cleaning pipe valves V3-1 and V3-2 which are adapted to open and close the first cleaning pipes 10-31 and 10-32, respectively.

On the other hand, the second branching pipe 10-22 is provided with a pair of second branching pipe valves V2-1 and V2-2 which are arranged so that the second filter 20-2 is interposed therebetween and which are adapted to open and close the second branching pipe 10-22.

The second branching pipe 10-22 is further connected to a pair of second cleaning pipes 10-33 and 10-34 which are connected thereto so that the second filter 20-2 is interposed therebetween and which are connected closer to the second filter 20-2 than the pair of second branching pipe valves V2-1 and V2-2.

The second cleaning pipes 10-33 and 10-34 are provided with second cleaning pipe valves V4-1 and V4-2 which are adapted to open and close the second cleaning pipes 10-33 and 10-34, respectively.

As a material constituting each of the pipes, use is preferably made of Al-containing austenite stainless steel (HR31) with an Al₂O₃ protective film formed on its surface (inner surface) by thermal oxidation, or a three-layer resin tube of PFA (tetrafluoroethylene perfluoroalkylvinylether copolymer)-nylon (registered trademark)-PFA, which has an extremely low gas permeability.

As the components such as the valves also, it is preferable to use Al-containing austenite stainless steel (HR31) with an Al₂O₃ protective film formed on its surface (inner surface) by thermal oxidation.

As the filters 20-1 and 20-2, a ceramic filter (having a filter diameter of 0.1 μm) with a built-in heater is preferable.

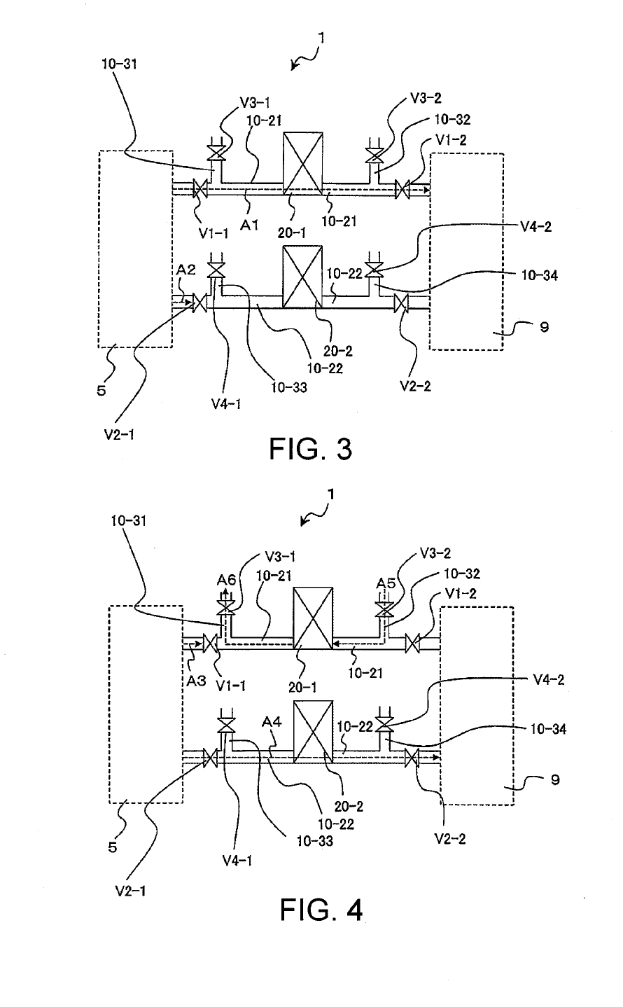

Next, referring to FIGS. 3 to 5, a brewed liquid filtering method using the brewed liquid filtering system 1 will be described.

First, the first branching pipe valves V1-1 and V1-2 shown in FIG. 3 are opened. At this time, the first cleaning pipe valves V3-1 and V3-2 are closed.

The second branching pipe valves V2-1 and V2-2 are closed also.

In this state, a brewed liquid is allowed to flow from the fermentation device 5 into the first branching pipe 10-21 as indicated by an arrow A1 in FIG. 3.

The brewed liquid flowing in is filtered by the first filter 20-1, which catches bacteria such as yeasts, and flows out to the filling device 9.

On the other hand, in the second branching pipe 10-22, the second branching pipe valves V2-1 and V2-2 are closed. Therefore, as indicated by an arrow A2 in FIG. 3, the brewed liquid is prevented from flowing in at a position where the second branching pipe valve V2-1 is arranged, without reaching the second filter 20-2.

Thus, in this state, the brewed liquid filtering system 1 performs filtering by using the first filter 20-1 only and does not use the second filter 20-2 for filtering.

Next, it is assumed that, due to a reason such as proliferation of the bacteria caught in the first filter 20-1, the first filter 20-1 is clogged and the time for cleaning and sterilizing has come.

Then, as shown in FIG. 4, the first branching pipe valves V1-1 and V1-2 are closed and the first cleaning pipe valves V3-1 and V3-2 are opened.

On the other hand, the second branching pipe valves V2-1 and V2-2 are opened and the second cleaning pipe valves V4-1 and V4-2 are closed.

In this state, as indicated by an arrow A3 in FIG. 4, in the first branching pipe 10-21, the brewed liquid is prevented from flowing in at a position where the first branching pipe valve V1-1 is arranged, without reaching the first filter 20-1.

On the other hand, in this state, the brewed liquid is allowed to flow from the fermentation device 5 into the second branching pipe 10-22 as indicated by an arrow A4 in FIG. 4.

The brewed liquid flowing in is filtered by the second filter 20-2, which catches bacteria such as yeasts, and is delivered to the filling device 9.

Thus, in this state, the brewed liquid filtering system 1 performs filtering by using the second filter 20-2 only and does not use the first filter 20-1 for filtering.

Next, as indicated by arrows A5 and A6 in FIG. 4, a cleaning liquid is allowed to flow from the first cleaning pipe 10-32 toward the first cleaning pipe 10-31.

Herein, the cleaning liquid is not particularly limited as far as the first filter 20-1 can be cleaned. However, in view of cleaning and sterilizing the bacteria caught in the first filter 20-1, pure water containing ozone is desirable. In this case, an ozone concentration is preferably 5 ppm to 100 ppm.

The cleaning liquid flowing in from the first cleaning pipe 10-32 toward the first cleaning pipe 10-31 flows into the first branching pipe 10-21 in a direction opposite to an inflow direction of the brewed liquid. As a consequence, the bacteria caught in the first filter 20-1 are removed and discharged from the first cleaning pipe 10-31 together with the cleaning liquid. When discharge of the cleaning liquid is finished, the first cleaning pipe valves V3-1 and V3-2 are closed.

If the first filter 20-1 has a built-in heater, the heater is heated so that the first filter 20-1 has a temperature of about 130° C. to 160° C. during cleaning. Thus, sterilization of the bacteria is carried out at the same time.

As described above, the brewed liquid filtering system 1 uses the second filter 20-2 while the first filter 20-1 is cleaned. Therefore, a line is not stopped due to clogging of the filter and a cost of the filtering process can be reduced.

Further, since the cost of the filtering process can be reduced, the entire cost of a brewing process can be reduced.

Thus, the brewed liquid filtering system 1 can reduce a production cost and has a structure suitable for cleaning of a filter.

Thereafter, when the time for cleaning and sterilizing the second filter 20-2 has come, the second branching pipe valves V2-1 and V2-2 are closed and the first branching pipe valves V1-1 and V1-2 are opened. Then, the brewed liquid is allowed to flow into the first branching pipe 10-21 and filtered using the first filter 20-1.

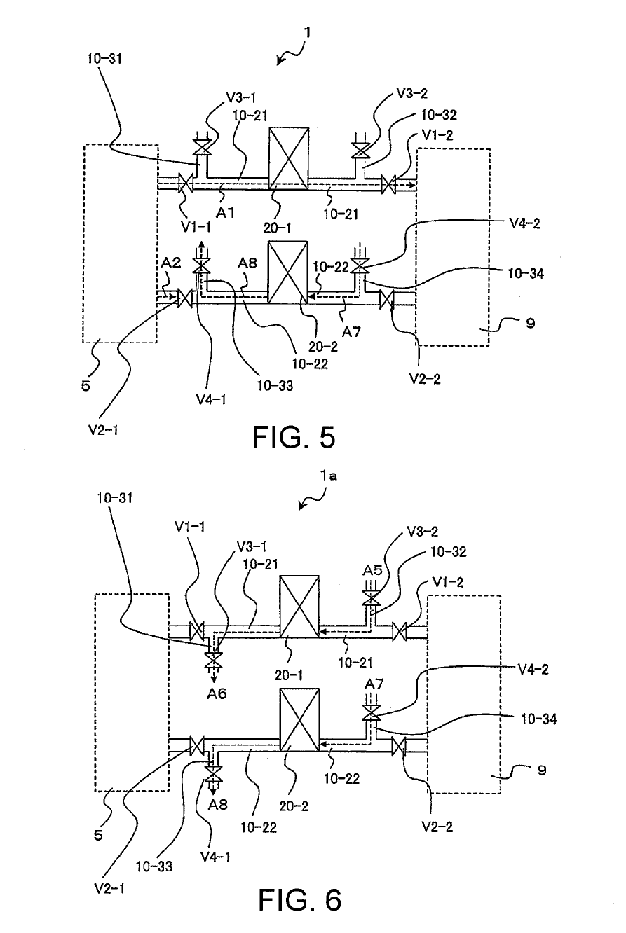

In this event, as indicated by arrows A7 and A8 in FIG. 5, the second cleaning pipe valves V4-1 and V4-2 are opened and the cleaning liquid is allowed to flow in from the second cleaning pipe 10-34 toward the second cleaning pipe 10-33 in the direction opposite to the inflow direction of the brewed liquid to clean the second filter. When discharge of the cleaning liquid is finished, the second cleaning pipe valves V4-1 and V4-2 are closed.

If the second filter 20-2 has a built-in heater, the heater is heated so that the second filter 20-2 has a temperature of about 130° C. to 160° C. during cleaning. Thus, sterilization of the bacteria is carried out at the same time.

Thereafter, when the time for cleaning of the first filter 20-1 has come, the above-described processes are repeated.

It is noted here that, in FIGS. 2 to 5, either of the first filter 20-1 and the second filter 20-2 can be used as a main filter. Therefore, the brewed liquid may be allowed to flow first into the second filter 20-2.

As described above, according to the first embodiment, the brewed liquid filtering system 1 has the first branching pipe 10-21 and the second branching pipe 10-22. The first branching pipe 10-21 and the second branching pipe 10-22 have the first filter 20-1 and the second filter 20-2, respectively. Further, the first branching pipe 10-21 and the second branching pipe 10-22 are connected to the first branching pipe valves V1-1 and V1-2 and the first cleaning pipes 10-31 and 10-32, and to the second branching pipe valves V2-1 and V2-2 and the second cleaning pipes 10-33 and 10-34, respectively. The brewed liquid filtering system is arranged so that, while one of the filters is cleaned, the brewed liquid can be filtered using the other filter.

Therefore, the brewed liquid filtering system 1 can reduce a production cost without stopping of the line due to clogging of the filter and has a structure suitable for cleaning of the filter.

Next, a brewed liquid filtering system 1a according to a second embodiment will be described with reference to FIG. 6.

In the second embodiment, components similar in function to those in the first embodiment are designated by the same reference numerals. A part of this embodiment different in structure from the first embodiment will mainly be described.

In the brewed liquid filtering system 1a according to the second embodiment, one of the first cleaning pipes 10-31 and 10-32 in the first embodiment is connected to an upper portion of the first branching pipe 10-21 to serve as an upper pipe and the other is connected to a lower portion thereof to serve as a lower pipe.

One of the second cleaning pipes 10-33 and 10-34 is connected to an upper portion of the second branching pipe 10-22 to serve as an upper pipe and the other is connected to a lower portion thereof to serve as a lower pipe.

As shown in FIG. 6, in the brewed liquid filtering system 1a, the first cleaning pipe 10-32 (first upper pipe) as one of the first cleaning pipes 10-31 and 10-32 which is provided on one side (on the side near the filling device 9, on the side at which the brewed liquid flows out), is connected to the upper portion of the first branching pipe 10-21. The first cleaning pipe 10-31 (first lower pipe) provided on the other side (on the side near the fermentation device 5, on the side at which the brewed liquid flows in), is connected to the lower portion of the first branching pipe 10-21.

Further, as shown in FIG. 6, in the brewed liquid filtering system 1a, the second cleaning pipe 10-34 (second upper pipe) as one of the second cleaning pipes 10-33 and 10-34 which is provided on one side (on the side near the filling device 9, on the side at which the brewed liquid flows out), is connected to the upper portion of the second branching pipe 10-22. The second cleaning pipe 10-33 (second lower pipe) provided on the other side (on the side near the fermentation device 5, on the side at which the brewed liquid flows in), is connected to the lower portion of the second branching pipe 10-22.

Herein, when the first filter 20-1 is cleaned, a cleaning liquid is allowed to flow in from the first cleaning pipe 10-32 (first upper pipe) toward the first cleaning pipe 10-31 (first lower pipe).

Then, as indicated by arrows A5 and A6 in FIG. 6, the cleaning liquid is allowed to flow in and discharged without fighting gravity. Therefore, it is possible to reduce a load required when the cleaning liquid is allowed to flow in and to prevent the cleaning liquid from remaining in the first branching pipe 10-21.

Likewise, when the second filter 20-2 is cleaned, the cleaning liquid is allowed to flow in from the second cleaning pipe 10-34 (second upper pipe) toward the second cleaning pipe 10-33 (second lower pipe).

Then, as indicated by arrows A7 and A8 in FIG. 6, the cleaning liquid is allowed to flow in and discharged without fighting gravity. Therefore, it is possible to reduce a load required for inflow of the cleaning liquid and to prevent the cleaning liquid from remaining in the second branching pipe 10-22.

As described above, according to the second embodiment, the brewed liquid filtering system 1a has the first branching pipe 10-21 and the second branching pipe 10-22. The first branching pipe 10-21 and the second branching pipe 10-22 have the first filter 20-1 and the second filter 20-2, respectively. Further, the first branching pipe 10-21 and the second branching pipe 10-22 are connected to the first branching pipe valves V1-1 and V1-2 and the first cleaning pipes 10-31 and 10-32, and to the second branching pipe valves V2-1 and V2-2 and the second cleaning pipes 10-33 and 10-34, respectively. The brewed liquid filtering system is arranged so that, while one of the filters is cleaned, the brewed liquid can be filtered using the other filter.

Therefore, an effect similar to that of the first embodiment is exhibited.

Further, according to the second embodiment, in the brewed liquid filtering system 1a, one of the first cleaning pipes 10-31 and 10-32 is connected to the upper portion of the first branching pipe 10-21 to serve as the first upper pipe and the other is connected to the lower portion thereof to serve as the first lower pipe.

Furthermore, one of the second cleaning pipes 10-33 and 10-34 is connected to the upper portion of the second branching pipe 10-22 to serve as the second upper pipe and the other is connected to the lower portion thereof to serve as the second lower pipe.

Therefore, when the filter is cleaned, the cleaning liquid is allowed to flow in and discharged without fighting gravity. Thus, it is possible to reduce a load required for inflow of the cleaning liquid and to prevent the cleaning liquid from remaining in the branching pipe.

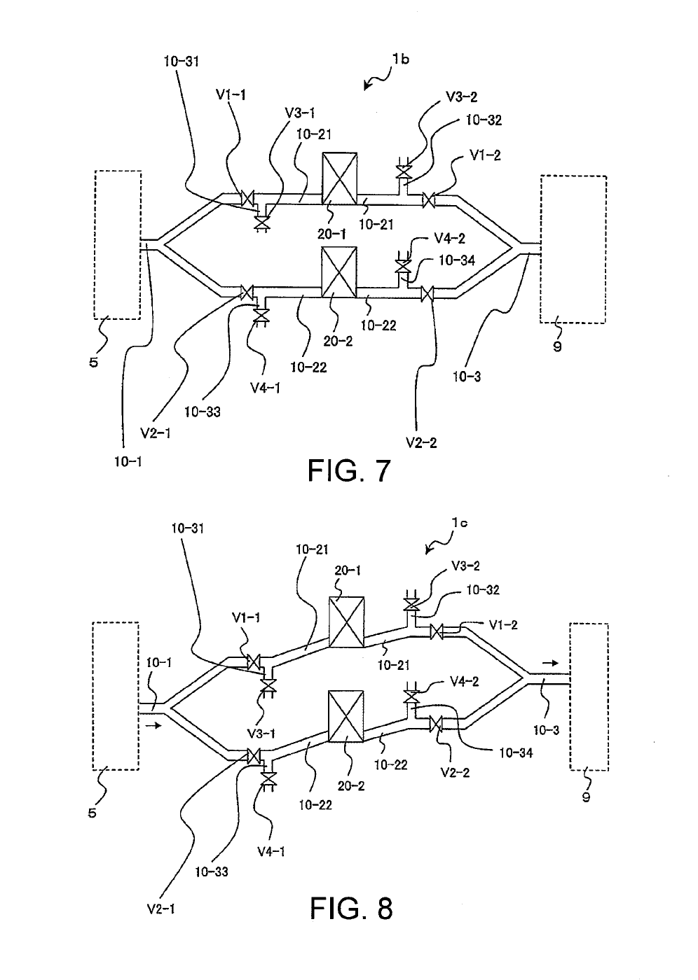

Next, a brewed liquid filtering system 1b according to a third embodiment will be described with reference to FIG. 7.

In the third embodiment, components similar in function to those in the second embodiment are designated by the same reference numerals. A part of this embodiment different from the second embodiment will mainly be described.

In the brewed liquid filtering system 1b according to the third embodiment, end portions of the first branching pipe 10-21 and the second branching pipe 10-22 in the second embodiment are connected by a first main pipe 10-1 and a second main pipe 10-3.

As shown in FIG. 7, in the brewed liquid filtering system 1b, the first main pipe 10-1 is connected to one end portions of the first branching pipe 10-21 and the second branching pipe 10-22 on the side at which the brewed liquid flows in.

The first main pipe 10-1 is connected to the fermentation device 5.

Further, in the brewed liquid filtering system 1b, the second main pipe 10-3 is connected to another end portions of the first branching pipe 10-21 and the second branching pipe 10-22 on the side at which the brewed liquid flows out.

The second main pipe 10-3 is connected to the filling device 9.

Thus, the first branching pipe 10-21 and the second branching pipe 10-22 are connected to each other by the first main pipe 10-1 and the second main pipe 10-3.

As described above, the system may have a structure in which the first branching pipe 10-21 and the second branching pipe 10-22 are connected to each other.

As described above, according to the third embodiment, the brewed liquid filtering system 1b has the first branching pipe 10-21 and the second branching pipe 10-22. The first branching pipe 10-21 and the second branching pipe 10-22 have the first filter 20-1 and the second filter 20-2, respectively. Further, the first branching pipe 10-21 and the second branching pipe 10-22 are connected to the first branching pipe valves V1-1 and V1-2 and the first cleaning pipes 10-31 and 10-32, and to the second branching pipe valves V2-1 and V2-2 and the second cleaning pipes 10-33 and 10-34, respectively. The brewed liquid filtering system is arranged so that, while one of the filters is cleaned, the brewed liquid can be filtered using the other filter.

Therefore, an effect similar to that of the second embodiment is exhibited.

Next, a brewed liquid filtering system 1c according to a fourth embodiment will be described with reference to FIG. 8.

In the fourth embodiment, components similar in function to those in the third embodiment are designated by the same reference numerals. A part of this embodiment different from the third embodiment will mainly be described.

In the brewed liquid filtering system 1c according to the fourth embodiment, the first branching pipe 10-21 in the third embodiment has a shape inclined downward from a part connected to the first upper pipe toward a part connected to the first lower pipe. The second branching pipe 10-22 has a shape inclined downward from a part connected to the second upper pipe toward a part connected to the second lower pipe.

As shown in FIG. 8, in the brewed liquid filtering system 1c, the first branching pipe 10-21 has a shape such that a part between the part connected to the first cleaning pipe 10-32 (first upper pipe) and the part connected to the first cleaning pipe 10-31 (first lower pipe) is inclined downward from the part connected to the first cleaning pipe 10-32 (first upper pipe) toward the part connected to the first cleaning pipe 10-31 (first lower pipe).

Further, in the brewed liquid filtering system 1c, the second branching pipe 10-22 has a shape such that a part between the part connected to the second cleaning pipe 10-34 (second upper pipe) and the part connected to the second cleaning pipe 10-33 (second lower pipe) is inclined downward from the part connected to the second cleaning pipe 10-34 (second upper pipe) toward the part connected to the second cleaning pipe 10-33 (second lower pipe).

With the above-mentioned shape, when each of the first filter 20-1 and the second filter 20-2 is cleaned, a cleaning water flows from the upper pipe toward the lower pipe without fighting gravity. Therefore, it is possible to reduce a load required for inflow of the cleaning liquid and to prevent the cleaning liquid from remaining in the branching pipe.

As described above, according to the fourth embodiment, the brewed liquid filtering system 1c has the first branching pipe 10-21 and the second branching pipe 10-22. The first branching pipe 10-21 and the second branching pipe 10-22 have the first filter 20-1 and the second filter 20-2, respectively. Further, the first branching pipe 10-21 and the second branching pipe 10-22 are connected to the first branching pipe valves V1-1 and V1-2 and the first cleaning pipes 10-31 and 10-32, and to the second branching pipe valves V2-1 and V2-2 and the second cleaning pipes 10-33 and 10-34, respectively. The brewed liquid filtering system is arranged so that, while one of the filters is cleaned, a brewed liquid can be filtered using the other filter.

Therefore, an effect similar to that of the third embodiment is exhibited.

Further, according to the fourth embodiment, in the brewed liquid filtering system 1c, the first branching pipe 10-21 has the shape inclined downward from the part connected to the first upper pipe toward the part connected to the first lower pipe and the second branching pipe 10-22 has the shape inclined downward from the part connected to the second upper pipe toward the part connected to the second lower pipe.

Therefore, when each of the first filter 20-1 and the second filter 20-2 is cleaned, the cleaning water flows from the upper pipe toward the lower pipe without fighting gravity. As a consequence, it is possible to reduce a load required for inflow of the cleaning liquid and to prevent the cleaning liquid from remaining in the branching pipe.

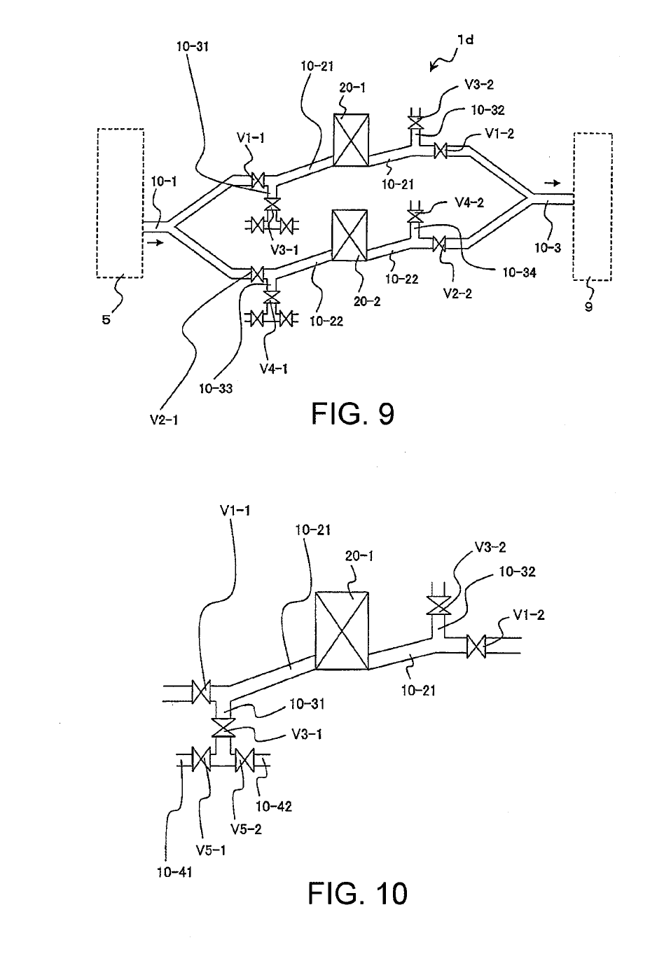

Next, a brewed liquid filtering system 1d according to a fifth embodiment will be described with reference to FIGS. 9 to 19.

In the fifth embodiment, components similar in function to those in the fourth embodiment are designated by the same reference numerals. A part of this embodiment different from the fourth embodiment will mainly be described.

In the brewed liquid filtering system 1d according to the fifth embodiment, each of the lower pipes in the fourth embodiment is connected to a discharging pipe and a brewed liquid pipe.

First, a structure of the brewed liquid filtering system 1d will be described with reference to FIGS. 9 to 11.

As shown in FIGS. 9 and 10, in the brewed liquid filtering system 1d, the first cleaning pipe 10-31 is connected to a first brewed liquid pipe 10-41 which allows a brewed liquid to flow therein and thereout and to a first discharging pipe 10-42 for discharging a cleaning liquid.

The first brewed liquid pipe 10-41 and the first discharging pipe 10-42 have a first brewed liquid pipe valve V5-1 and a first discharging pipe valve V5-2, respectively, and are adapted to be openable and closable by the valves.

The first brewed liquid pipe 10-41 is connected to the fermentation device 5 (see FIG. 1).

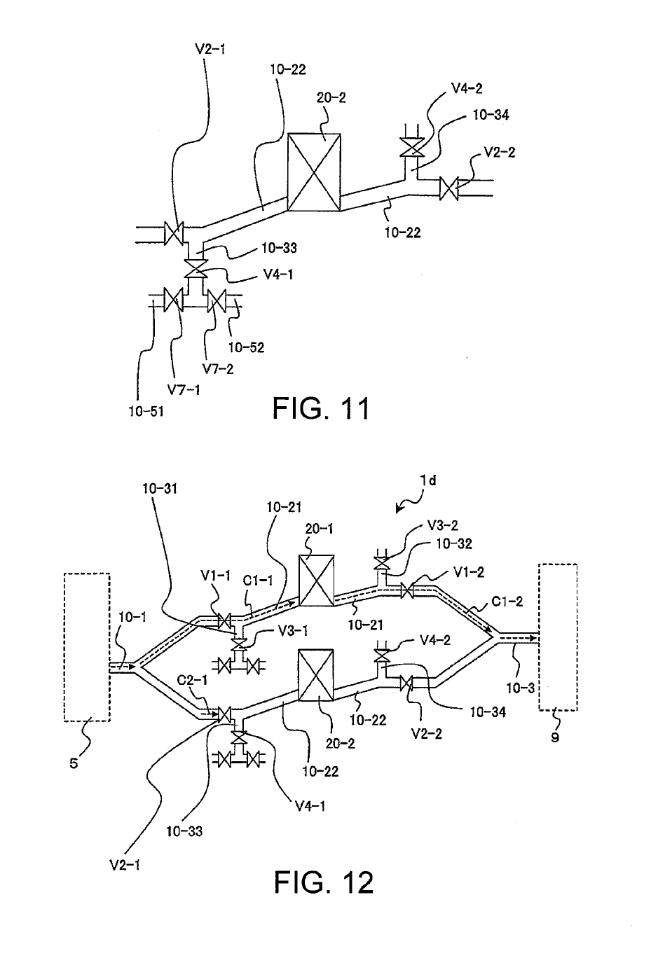

On the other hand, as shown in FIGS. 9 and 11, in the brewed liquid filtering system 1d, the second cleaning pipe 10-33 is connected to a second brewed liquid pipe 10-51 which allows the brewed liquid to flow therein and thereout and to a second discharging pipe 10-52 for discharging the cleaning liquid.

The second brewed liquid pipe 10-51 and the second discharging pipe 10-52 have a second brewed liquid pipe valve V7-1 and a second discharging pipe valve V7-2, respectively, and are adapted to be openable and closable by the valves.

The second brewed liquid pipe 10-51 is connected to the fermentation device 5 (see FIG. 1).

Next, referring to FIGS. 12 to 19, a brewed liquid filtering method using the brewed liquid filtering system 1 will be described.

First, the first branching pipe valves V1-1 and V1-2 shown in FIG. 12 are opened. At this time, the first cleaning pipe valves V3-1 and V3-2 are closed.

The second branching pipe valves V2-1 and V2-2 are closed also.

In this state, as indicated by an arrow C1-1 in FIG. 12, the brewed liquid is allowed to flow from the fermentation device 5 into the first branching pipe 10-21.

The brewed liquid flowing in is filtered by the first filter 20-1, which catches bacteria such as yeasts, and flows out to the filling device 9 as indicated by an arrow C1-2.

On the other hand, in the second branching pipe 10-22, the second branching pipe valves V2-1 and V2-2 are closed. Therefore, as indicated by an arrow C2-1 in FIG. 12, the brewed liquid is prevented from flowing in at a position where the second branching pipe valve V2-1 is arranged, without reaching the second filter 20-2.

Next, it is assumed that, due to a reason such as proliferation of the bacteria caught in the first filter 20-1, the first filter 20-1 is clogged and the time for cleaning has come.

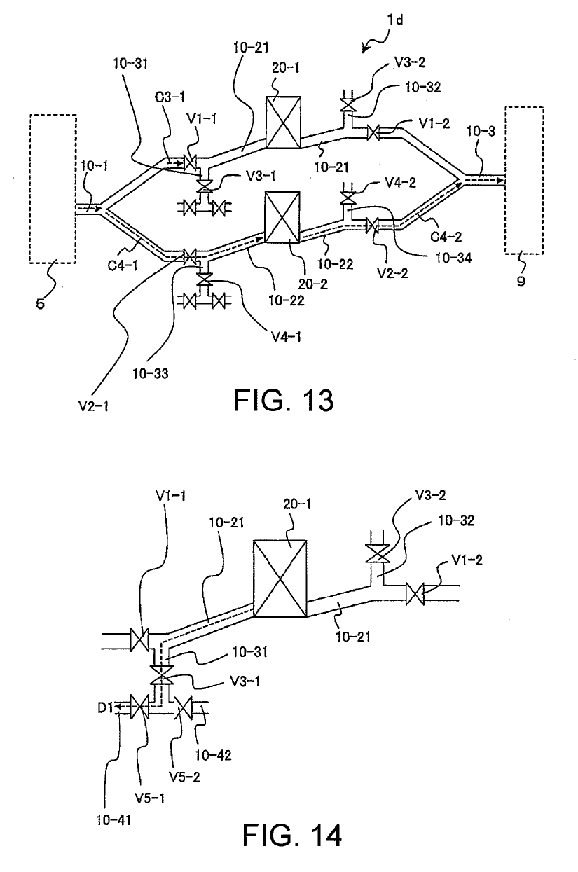

Then, as shown in FIG. 13, the first branching pipe valves V1-1 and V1-2 are closed and the first cleaning pipe valves V3-1 and V3-2 are opened.

On the other hand, the second branching pipe valves V2-1 and V2-2 are opened and the second cleaning pipe valves V4-1 and V4-2 are closed.

In this state, as indicated by an arrow C4-1 in FIG. 13, the brewed liquid is allowed to flow from the fermentation device 5 into the second branching pipe 10-22.

The brewed liquid flowing in is filtered by the second filter 20-2, which catches bacteria such as yeasts, and is delivered into the filling device 9 as indicated by an arrow C4-2.

On the other hand, in the first branching pipe 10-21, as indicated by an arrow C3-1 in FIG. 13, the brewed liquid is prevented from flowing in at a position where the first branching pipe valve V1-1 is arranged, without reaching the first filter 20-1.

Next, as shown in FIG. 14, the first cleaning pipe valve V3-1 and the first brewed liquid pipe valve V5-1 are opened. As indicated by an arrow D1, the brewed liquid before filtering which is left between the first filter 20-1 and the first branching pipe valve V1-1 is allowed to flow into the first brewed liquid pipe 10-41 to be collected. When collection is finished, the first brewed liquid pipe valve V5-1 is closed.

As described above, before the first filter 20-1 is cleaned, the brewed liquid before filtering which is left in the first branching pipe 10-21 is collected. Therefore, the brewed liquid is not wastefully discarded so that a production cost of the brewed liquid can be reduced.

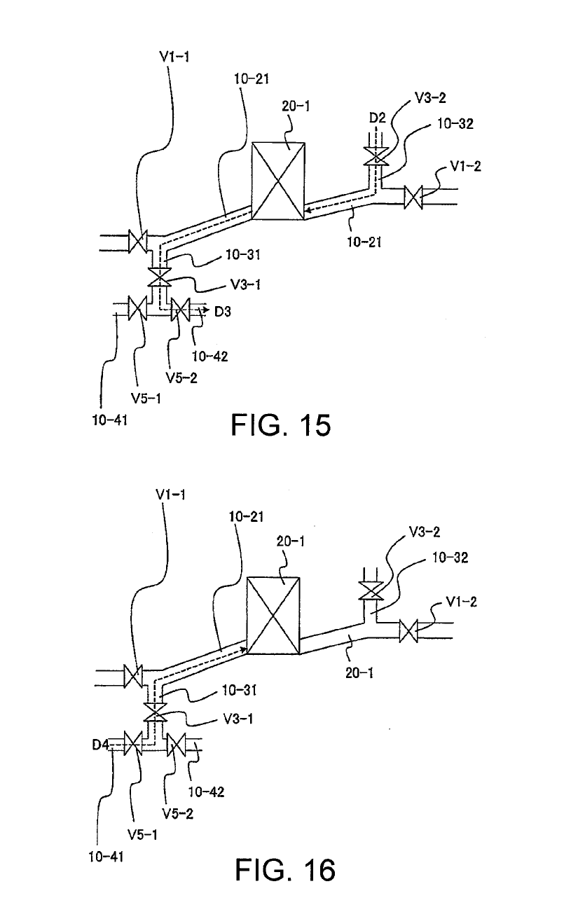

Next, as shown in FIG. 15, the first cleaning pipe valves V3-1 and V3-2 and the first discharging pipe valve V5-2 are opened. As indicated by an arrow D2, the cleaning liquid is allowed to flow in from the first cleaning pipe 10-32 toward the first cleaning pipe 10-31.

The cleaning liquid flowing in flows into the first branching pipe 10-21 in a direction opposite to an inflow direction of the brewed liquid and removes the bacteria caught in the first filter 20-1. As indicated by an arrow D3, the bacteria together with the cleaning liquid pass through the first cleaning pipe 10-31 to be discharged from the first discharging pipe 10-42. When the cleaning liquid is discharged, the first discharging pipe valve V5-2 is closed.

Next, as shown in FIG. 16, the first brewed liquid pipe valve V5-1 is opened. As indicated by an arrow D4, the brewed liquid is allowed to flow from the first brewed liquid pipe 10-41 via the first cleaning pipe 10-31 toward the first filter 20-1. A part of the first branching pipe between the first branching pipe valve V1-1 and the first filter 20-1 is filled with the brewed liquid. When filling is finished, the first brewed liquid pipe valve V5-1 and the first cleaning pipe valves V3-1 and V3-2 are closed.

As described above, after the cleaning liquid is discharged, the first branching pipe 10-21 is filled with the brewed liquid. Therefore, when filtering is performed using the first filter 20-1 again, the brewed liquid is allowed to flow without stopping a production line.

Next, when the time for cleaning of the second filter 20-2 has come, the second branching pipe valves V2-1 and V2-2 are closed and the first branching pipe valves V1-1 and V1-2 are opened so that the brewed liquid is allowed to flow in the first branching pipe 10-21, as shown in FIG. 12. The brewed liquid is filtered using the first filter 20-1.

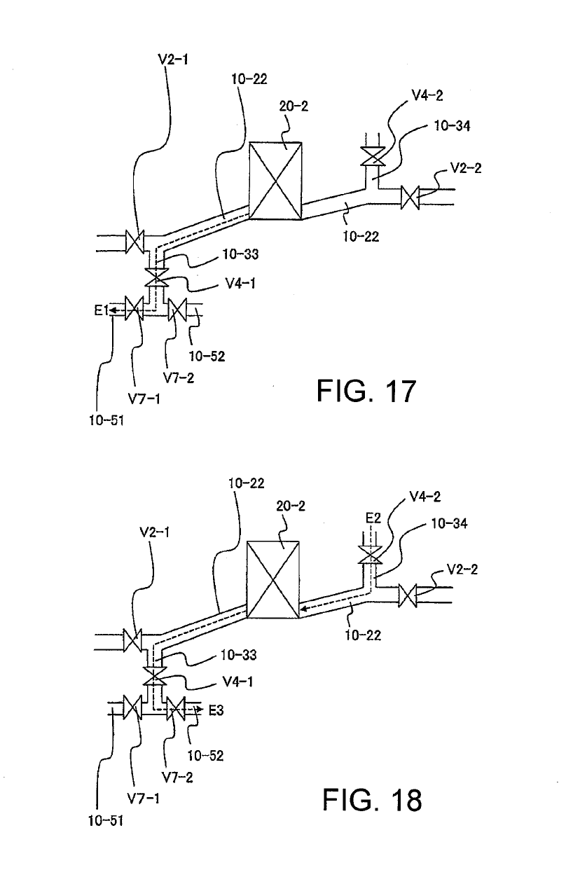

Next, as shown in FIG. 17, the second cleaning pipe valve V4-1 and the second brewed liquid pipe valve V7-1 are opened and, as indicated by an arrow E1, the brewed liquid before filtering which is left between the second filter 20-2 and the second branching pipe valve V2-1 is allowed to flow into the second brewed liquid pipe 10-51 to be collected. When collection is finished, the second brewed liquid pipe valve V7-1 is closed.

Next, as shown in FIG. 18, the second cleaning pipe valves V4-1 and V4-2 and the second discharging pipe valve V7-2 are opened and, as indicated by an arrow E2, the cleaning liquid is allowed to flow in from the second cleaning pipe 10-34 toward the second cleaning pipe 10-33.

The cleaning liquid flowing in flows into the second branching pipe 10-22 in the direction opposite to the inflow direction of the brewed liquid and removes the bacteria caught in the second filter 20-2. As indicated by an arrow E3, the bacteria together with the cleaning liquid pass through the second cleaning pipe 10-33 to be discharged from the second discharging pipe 10-52. When discharge is finished, the second discharging pipe valve V7-2 is closed.

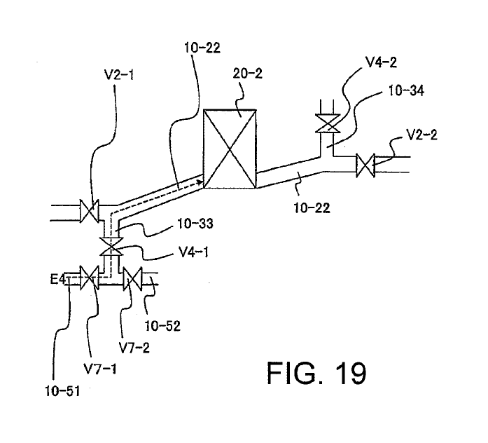

Next, as shown in FIG. 19, the second brewed liquid pipe valve V7-1 is opened and, as indicated by an arrow E4, the brewed liquid is allowed to flow from the second brewed liquid pipe 10-51 via the second cleaning pipe 10-33. A part of the second branching pipe 10-22 between the second branching pipe valve V2-1 and the second filter 20-2 is filled with the brewed liquid. When filling is finished, the second brewed liquid pipe valve V7-1 and the second cleaning pipe valves V4-1 and V4-2 are closed.

Thereafter, when the time for cleaning of the first filter 20-1 has come, the above-described processes are repeated.

As described above, according to the fifth embodiment, the brewed liquid filtering system 1d has the first branching pipe 10-21 and the second branching pipe 10-22. The first branching pipe 10-21 and the second branching pipe 10-22 have the first filter 20-1 and the second filter 20-2, respectively. Further, the first branching pipe 10-21 and the second branching pipe 10-22 are connected to the first branching pipe valves V1-1 and V1-2 and the first cleaning pipes 10-31 and 10-32, and to the second branching pipe valves V2-1 and V2-2 and the second cleaning pipes 10-33 and 10-34, respectively. The brewed liquid filtering system is arranged so that, while one of the filters is cleaned, the brewed liquid can be filtered using the other filter.

Therefore, an effect similar to that of the fourth embodiment is exhibited.

Further, according to the fifth embodiment, in the brewed liquid filtering system 1d, each of the lower pipes is connected to the discharging pipe and the brewed liquid pipe.

Therefore, the brewed liquid is not wastefully discarded so that a production cost of the brewed liquid can be reduced.

When cleaning of the filter is finished and the filter is used again, the brewed liquid is allowed to flow without stopping a production line.

### INDUSTRIAL APPLICABILITY

In the foregoing embodiments, description has been made about the case where the present invention is applied to a brewing apparatus for brewing a Japanese sake or a beer. However, the present invention is not limited thereto but is applicable to any apparatus which is required to filter other brews, such as a wine and a cider, and other brewed liquids.

### DESCRIPTION OF REFERENCE NUMERALS

1 brewed liquid filtering system
3 saccharification device
5 fermentation device
9 filling device
10-21 first branching pipe
10-22 second branching pipe
10-31 first cleaning pipe
10-32 first cleaning pipe
10-33 second cleaning pipe
10-34 second cleaning pipe
10-41 first brewed liquid pipe
10-42 first discharging pipe
10-51 second brewed liquid pipe
10-52 second discharging pipe
20-1 first filter
20-2 second filter
V1-1 first branching pipe valve
V1-2 first branching pipe valve
V2-1 second branching pipe valve
V2-2 second branching pipe valve
V3-1 first cleaning pipe valve
V3-2 first cleaning pipe valve
V4-1 second cleaning pipe valve
V4-2 second cleaning pipe valve
V5-1 first brewed liquid pipe valve
V5-2 first discharging pipe valve
V7-1 second brewed liquid pipe valve
V7-2 second discharging pipe valve

1. A brewed liquid filtering system comprising:
a first branching pipe having a first filter and allowing a brewed liquid to flow therein and thereout;
a second branching pipe having a second filter and allowing the brewed liquid to flow therein and thereout;
a pair of first branching pipe valves provided to the first branching pipe so that the first filter is interposed therebetween;
a pair of second branching pipe valves provided to the second branching pipe so that the second filter is interposed therebetween;
a pair of first cleaning pipes which are connected to the first branching pipe so that the first filter is interposed therebetween, which are connected closer to the first filter than the pair of first branching pipe valves, and which are openable and closable; and
a pair of second cleaning pipes which are connected to the second branching pipe so that the second filter is interposed therebetween, which are connected closer to the second filter than the pair of second branching pipe valves, and which are openable and closable.

2. The brewed liquid filtering system as claimed in claim 1, comprising:
a first main pipe connected to one end portions of the first branching pipe and the second branching pipe on the side at which the brewed liquid flows in; and
a second main pipe connected to another end portions of the first branching pipe and the second branching pipe on the side at which the brewed liquid flows out.

3. The brewed liquid filtering system as claimed in claim 1, wherein each of the first filter and the second filter is provided with a heater for sterilization.

4. The brewed liquid filtering system as claimed in claim 1, wherein the pair of first cleaning pipes comprise:
a first upper pipe provided on the side at which the brewed liquid flows out and connected to an upper portion of the first branching pipe; and
a first lower pipe provided on the side at which the brewed liquid flows in and connected to a lower portion of the first branching pipe.

5. The brewed liquid filtering system as claimed in claim 4, wherein:
the first branching pipe is inclined downward from a part connected to the first upper pipe toward a part connected to the first lower pipe.

6. The brewed liquid filtering system as claimed in claim 4, wherein:
the first lower pipe is connected to:
a first brewed liquid pipe which allows the brewed liquid to flow therein and thereout and which is openable and closable; and
a first discharging pipe which is operable and closable.

7. The brewed liquid filtering system as claimed in claim 1, wherein:
the pair of second cleaning pipes comprise:
a second upper pipe provided on the side at which the brewed liquid flows out and connected to an upper portion of the second branching pipe; and
a second lower pipe provided on the side at which the brewed liquid flows in and connected to a lower portion of the second branching pipe.

8. The brewed liquid filtering system as claimed in claim 7, wherein:
the second branching pipe is inclined downward from a part connected to the second upper pipe to a part connected to the second lower pipe.

9. The brewed liquid filtering system as claimed in claim 7, wherein:
the second lower pipe is connected to:
a second brewed liquid pipe which allows the brewed liquid to flow therein and thereout and which is openable and closable; and
a second discharging pipe which is operable and closable .

10. A brewed liquid filtering method using a brewed liquid filtering system comprising:
a first branching pipe having a first filter and allowing a brewed liquid to flow therein and thereout;
a second branching pipe having a second filter and allowing the brewed liquid to flow therein and thereout;
a pair of first branching pipe valves provided to the first branching pipe so that the first filter is interposed therebetween;
a pair of second branching pipe valves provided to the second branching pipe so that the second filter is interposed therebetween;
a pair of first cleaning pipes which are connected to the first branching pipe so that the first filter is interposed therebetween, which are connected closer to the first filter than the pair of first branching pipe valves, and which are openable and closable; and
a pair of second cleaning pipes which are connected to the second branching pipe so that the second filter is interposed therebetween, which are connected closer to the second filter than the pair of second branching pipe valves, and which are openable and closable,
the method comprising the steps of:
(a) filtering the brewed liquid using the first filter by opening the pair of first branching pipe valves and closing the pair of second branching pipe valves to allow the brewed liquid to flow into the first branching pipe;
(b) filtering the brewed liquid using the second filter by closing the first branching pipe valves and opening the second branching pipe valves, when the time for cleaning of the first filter has come, to allow the brewed liquid to flow into the second branching pipe; and
(c) cleaning the first filter by opening the first cleaning pipes and allowing a cleaning liquid to flow from the first cleaning pipe to the first filter in a direction opposite to an inflow direction of the brewed liquid.

11. The brewed liquid filtering method as claimed in claim 10, further comprising a step of:
(d) cleaning the second filter by closing the second branching pipe valves and opening the second cleaning pipes, when the time for cleaning of the second filter has come, to allow the cleaning liquid to flow from the second cleaning pipe to the second filter in the direction opposite to the inflow direction of the brewed liquid.

12. The brewed liquid filtering method as claimed in claim 10, wherein the step (c) includes a step of sterilizing the first filter by heating.

13. The brewed liquid filtering method as claimed in claim 10, wherein:
the pair of first cleaning pipes comprise:
a first upper pipe provided on the side at which the brewed liquid flows out and connected to an upper portion of the first branching pipe; and
a first lower pipe provided on the side at which the brewed liquid flows in and connected to a lower portion of the first branching pipe,
the step (c) being a step of cleaning the first filter by allowing the cleaning liquid to flow in from the first upper pipe toward the first lower pipe.

14. The brewed liquid filtering method as claimed in claim 13, wherein:
the first lower pipe is connected to:
a first brewed liquid pipe which allows the brewed liquid to flow therein and thereout and which is openable and closable; and
a first discharging pipe which is for discharging the cleaning liquid and which is openable and closable;
the step (c) comprising the steps of:
collecting the brewed liquid before filtering which is left between the first filter and the first branching pipe valve by opening the first brewed liquid pipe to allow the brewed liquid to flow into the first brewed liquid pipe;
closing the first brewed liquid pipe when collection of the brewed liquid is finished;
allowing the cleaning liquid to flow from the first upper pipe toward the first lower pipe;
cleaning the first filter by discharging the cleaning liquid from the first discharging pipe;
closing the first discharging pipe after the cleaning liquid is discharged; and opening the first brewed liquid pipe to allow the brewed liquid to flow from the first lower pipe toward the first filter.

15. The brewed liquid filtering method as claimed in claim 11, wherein the step (d) includes a step of sterilizing the second filter by heating.

16. The brewed liquid filtering method as claimed in claim 11 wherein:
the pair of second cleaning pipes comprise:
a second upper pipe provided on the side at which the brewed liquid flows out and connected to an upper portion of the second branching pipe; and
a second lower pipe provided on the side at which the brewed liquid flows in and connected to a lower portion of the second branching pipe,
the step (d) being a step of cleaning the second filter by allowing the cleaning liquid to flow from the second upper pipe toward the second lower pipe.

17. The brewed liquid filtering method as claimed in claim 16, wherein:
the second lower pipe is connected to:
a second brewed liquid pipe which allows the brewed liquid to flow therein and thereout and which is openable and closable; and
a second discharging pipe which is for discharging the cleaning liquid and which is openable and closable;
the step (d) comprising the steps of:
collecting the brewed liquid before filtering which is left between the second filter and the second branching pipe valve by opening the second brewed liquid pipe to allow the brewed liquid to flow into the second brewed liquid pipe;
closing the second brewed liquid pipe when collection of the brewed liquid is finished;
allowing the cleaning liquid to flow from the second upper pipe toward the second lower pipe;
cleaning the second filter by discharging the cleaning liquid from the second discharging pipe;
closing the second discharging pipe after the cleaning liquid is discharged; and opening the second brewed liquid pipe to allow the brewed liquid to flow from the second lower pipe toward the second filter.

18. The brewed liquid filtering method as claimed in any one of claims 10 through 17, wherein: the cleaning liquid contains ozone.

19. The brewed liquid filtering method as claimed in claim 11, wherein the steps (a) to (d) are repeated.

20. A brewed liquid manufacturing method including, as a process, the brewed liquid filtering method claimed in claim 10.
